(19) United States
(12) Patent Application Publication
(10) Pub. No.: US 2005/0228811 A1
(43) Pub. Date: Oct. 13, 2005

(54) Method of and system for compressing and decompressing hierarchical data structures

(76) Inventor: Russell Perry, Bristol (GB)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/100,801

(22) Filed: Apr. 7, 2005

(30) Foreign Application Priority Data
Apr. 7, 2004 (GB) 0407872.1

(51) Int. Cl. G06F 17/00

(52) U.S. Cl. 707/101

(57) ABSTRACT

A method is provided of compressing a hierarchical data structure in which the structure and the data content are separated and compressed separately. Data tags in the structure are replaced with symbols from a dictionary. The structure is rearranged into a table of occurrences of items of the structure or content against a YPath and a ZPath of each item. The YPaths and ZPaths are rearranged and compressed so as to exploit patterns in the Y and ZPaths. The occurrences of items are compressed by dividing the table into a plurality of regions outside of which plurality of regions the table is empty, and compressing the regions using a binary image compression method. The data content is rearranged to form groups of associated data items, such that each group may be compressed separately using different compression methods and may exploit similarities between data items within a group. There is also provided a method of decompressing a compressed hierarchical data structure which has been compressed using the compression method.

### TECHNICAL FIELD

This invention relates to a method of and system for compressing and decompressing hierarchical data structures, such as XML data structures.

### BACKGROUND TO THE INVENTION

Data can often be represented as a hierarchical or “tree-like” structure. Such a structure can have a number of nodes representing data items, each node can have sub-nodes, each sub-node can have its own sub-nodes and so on. An example of a tree-like data structure 100 is shown in FIG. 1. The first node 102 is the highest level node or the “root” node. Sub-nodes 104 of the root node 102 can be represented by displaying “branches” 106 connecting each sub-node 104 with the root node 102. Sub-nodes 108 of one of the sub-nodes 104 can be connected to the associated sub-node 104 with further branches 110. In this way any node in the whole data structure 100 can be reached by starting at the root node 102 and traversing the branches which pass through nodes of higher levels until the specific node is reached.

A node which has sub-nodes can be called the “parent” of its sub-nodes. The immediate sub-nodes are called “child” nodes of the parent. The root node is the highest node in the hierarchy.

An exemplary structure used to describe such a hierarchical structure within computer systems will now be described. The data structure is typically stored as a “file” in the computer's permanent storage system such as a hard disk. Each node is identified within the file using a start and often also an end “tag”. These tags are indicia which describe the nature of their associated data. Data associated with each node lies between the start and end tags. Sub-nodes or children of a node have their tags and data adjacent the data associated with the parent and advantageously in between the parent's tags.

There are numerous ways of implementing a tree-like data structure. One common implementation is to use XML (Extensible Mark-up Language). XML is extensively used for representing, storing and exchanging data, especially over the internet. The most recent version of the XML specification at the time of drafting the patent is available on the internet at http://www.w3.org/TR/REC-xml.

An example of an XML data structure embodying an address book is shown in FIG. 2. XML defines data items by using start and end tags. XML uses a slightly different notation than general hierarchical data structures. Whereas each start tag, end tag and data between start and end tags is normally called a node, in XML a data item comprising a start and end tag and (optionally) having data between them is called an “element”. Therefore the root node 102 of the data structure 100 in FIG. 1 would be called the root element if implemented using XML.

Within the address book, XML is used to define data structures. In the example shown in FIG. 2, XML is used to define an address book data structure, having sub-elements for addresses, and each address having further sub-elements for first name, street address and so on. Alternatively XML can be used to define documents or objects having elements for headings, sub-headings, paragraphs and other components such as graphics. This data structure can be visualised as a tree-like structure with elements and branches as shown in FIG. 3. For clarity only a selection of elements and nodes is shown in FIG. 3.

A properly formed XML data structure does not allow a parent element to terminate (with its end tag) before any of its child elements. Thus a child element can be easily associated with its parent, and can have only one immediate parent in the level directly above the level of the child element. The XML data structure also specifies that each start tag must have an associated end tag. There is one exception to this rule. If there is no data between associated tags of an element then the start and end tags can be replaced by a single “empty element” tag. This would comprise a start tag with an additional forward slash character following the element name. Thus <addBook/> is an empty address book element.

In the XML data structure illustrated in FIG. 2, the first line <?XML version=“1.0”?> indicates that the following information is in XML format. The first XML node is found in line 2. This node “<addBook>” is the start tag of the root element of the data structure. An XML start tag comprises an element name (which is often descriptive of the element it represents) enclosed within angled brackets. The associated end tag is identical to the start tag but with a forward slash character added before the element name. The end tag for the root element can be found in line 32 in this example.

A further type of node which may occur within an XML data structure is an attribute. Attributes are nodes which appear within the start tag of an element and convey some information about that element. An example can be found in the XML document in FIG. 2. The start tag of an “address” element in line 3 contains a “type” attribute indicating that the address element is a “uk” type. The text “uk” is called the value of the attribute. Attribute names and their values can be chosen to be descriptive of the information they are conveying.

Data and sub-elements between the tags of elements in XML are often indented as shown in FIG. 2 to indicate to a human reader that it is associated with the element. Such indentation is not required by a computer. Data and sub-elements within the sub-elements can be further indented to highlight the structure of the XML data. This feature can be used together with descriptive element names in order to produce a data structure which can easily be interpreted and edited by a human without using special XML aware software or apparatus.

A side-effect of these features of XML is that XML documents or data structures tend to be relatively large for the type and amount of data they contain, when compared to other more compact forms of representing data sets. The XML data structure contains a lot of data (meta data) in tags and hence tends to be verbose. This has disadvantages when storing XML files as more storage space tends to be required by each file. Furthermore when transferring the files using a communication medium such as the internet, more information must be transmitted, which increases transmission time and consumes bandwidth.

Some of these issues can be addressed by compression of the data. A compressed file reduces demands on storage and improves efficiency of transmission of the file, although this can be at the expense of increased computational demands to process the file at its destination.

A number of compression algorithms exist which can be applied to computer files in general and not just to tree-like data structures and documents. Examples are zip compression and gzip. However these algorithms are intended for all types of files stored on computers and are not optimised for particular types such as tree-like data structures or XML files. The reader may wish to refer to:
“The Data Compression Book” 2^{nd} Edition by Mark Nelson and Jean-Loup Gaily, which describes several text compression algorithms.
“Xmill: An efficient Compressor for XML data”, by Hartrnut Liefke and Dan Suciu, ACM SIGMOD Conference 2000, pp. 153-164, where a compressor for XML is described.

At http://www.w3.org/TR/wbxml where a method of serialising XML to a binary stream is disclosed.

Navigation of a Tree Structure

Any element, attribute or data node in a hierarchical data structure can be referenced individually by traversing the appropriate branches as explained above. In practice for an XML or a tree structure each node is referred to by specifying an XPath expression that evaluates to that node. XPath is a language for addressing parts of an XML data structure and its current specification is available on the internet at http://www.w3.org/TR/path. An example of a simple XPath expression takes the form A[l]/B[m]/C[n]/ . . . where A, B, C are node names and l, m, n denote the ordinal position of the element of the specified name among other elements at the same level having the same name. This form will be used herein.

In the example of an XML document in FIG. 2, the XPath of the “firstname” element in line 4 in the first address is addBook[1]/address[1]/firstname[1]. The XPath of the “street” element of the fourth address in line 28 is addBook[1]/address[4]/street[1].

The ordinal position of the street element has the value 1 at that level as it is the first “street” element occurring at that level and under the same parent, even though it is the third element appearing under the parent.

There are other nodes that make up an XML document, but which are not elements or attributes. The most common of these is the text node. Text nodes are not actually visible in a printed XML document. A text node contains the actual data embedded in the XML document. So the value “jane” should be thought of as being held inside a text node inside the “firstname” element. Because text nodes do not have a name like elements, a default name “TEXT” is given to all text nodes. This default name can be replaced with any string so long as it is not itself an element name in the document to be compressed. Therefore, the XPath of the text “jane” in line 11 of the example XML data structure is addBook[1]/address[2]/firstname[ ]/TEXT[1]. Other node types which are assigned a default name comprise COMMENT, CDATA and PCDATA, and are defined by the XML standard.

The XPath can be used to derive two further parts, the YPath and the ZPath. The YPath of a node comprises the node names from the node's XPath. The ZPath comprises the node's ordinal positions from the XPath. For example the XPath of the “street” element in line 28 of FIG. 2 is addBook[1]/address[4]/street[1]. The YPath is addBook/address/street. The ZPath is 1/4/1. The “order” of a node is the number of integers in its ZPath. This is also equal to the number of element names in its YPath. The root node has the fewest node names and integers in its XPath, and is the lowest order node.

One variation to the above XPath rule is the representation of attributes. As an example, the XPath of the “type” attribute within the “address” element start tag in line 3 is addBook[1]/address[1]/@type. The name of the attribute is preceded by a “@” character to indicate that it is an attribute. Also, the attribute does not have an ordinal position. This is because XML only allows one attribute of a particular name within an element start tag. Thus the ordinal position is not strictly required.

### SUMMARY OF THE INVENTION

According to a first aspect of the present invention there is provided a method of compressing hierarchical data as defined in appended claim 1.

According to a second aspect of the present invention there is provided a computer program for controlling a programmable data processor to perform the method as defined in appended claim 1.

According to a third aspect of the present invention there is provided a data processor adapted to compress hierarchical data as defined in appended claim 39.

According to a fourth aspect of the present invention there is provided a method of decompressing compressed hierarchical data as claimed in appended claim 67.

According to a fifth aspect of the present invention there is provided a data processor adapted to decompress compressed hierarchical data as defined in appended claim 82.

According to a sixth aspect of the present invention there is provided a computer program for controlling a data processor to perform the method defined in claim 67.

Preferred features of the invention are set out in the dependent claims.

### BRIEF DESCRIPTION OF THE DRAWINGS

The invention will now be described, by way of example only, with reference to the accompanying drawings, in which:

FIG. 1 shows an example of the tree-like data structure;

FIG. 2 shows an example of an XML data structure;

FIG. 3 shows part of the XML data structure of FIG. 2 represented as a tree-like structure;

FIG. 4 shows a flow diagram of the steps taken to compress a tree-like data structure according to an embodiment of the present invention;

FIG. 5 shows a computer system for use with the invention;

FIG. 6 shows a flow diagram of steps taken when creating a dictionary table of an XML data structure;

FIG. 7 shows an example of a dictionary table produced by the steps in FIG. 6;

FIG. 8 shows an example of a YZ-table which illustrates the structure and order of data within a tree-like data structure;

FIG. 9 shows the XML data structure of FIG. 2 with a ZPath and reduced YPath indicated for each node;

FIG. 10 shows an example of a values table containing data from a tree-like data structure;

FIG. 11 shows a flow diagram of a method to compress ZPaths according to an embodiment of the invention;

FIG. 12 shows an example of a list of ZPaths taken from the YZ-table of FIG. 8 and compressed using the method in FIG. 11;

FIG. 13 is a flow diagram of a method of compressing YPaths according to an embodiment of the invention;

FIG. 14 shows an example of a list of YPaths taken from the YZ-table of FIG. 8 and compressed using the steps in FIG. 13;

FIG. 15 shows a binary image representation of the example YZ-table of FIG. 8;

FIGS. 16 to 18 illustrate a method of representing and compressing regions of the table of FIG. 15;

FIG. 19 shows a reduced representation of the region of FIG. 17;

FIG. 20 shows an example of a structure of the compressed values table FIG. 10;

FIG. 21 shows an example of a structure of the encoded dictionary table of FIG. 7;

FIG. 22 is an example of a structure of encoded dictionary table data from the encoded dictionary table of FIG. 21;

FIG. 23 is an example of a structure of a compressed tree-like data structure according to an embodiment of the invention;

FIG. 24 is a flow diagram of steps taken to decompress the structure of FIG. 23 according to an embodiment of the invention;

FIG. 25 is a flow diagram of steps taken to decompress ZPaths according to an embodiment of the invention;

FIG. 26 is a table containing steps from FIG. 25 in the order executed in order to decompress an example of compressed ZPaths;

FIG. 27 is a flow diagram of steps taken to decompress YPaths according to an embodiment of the invention; and

FIG. 28 is a table containing steps from FIG. 27 in the order executed in order to decompress an example of compressed YPaths.

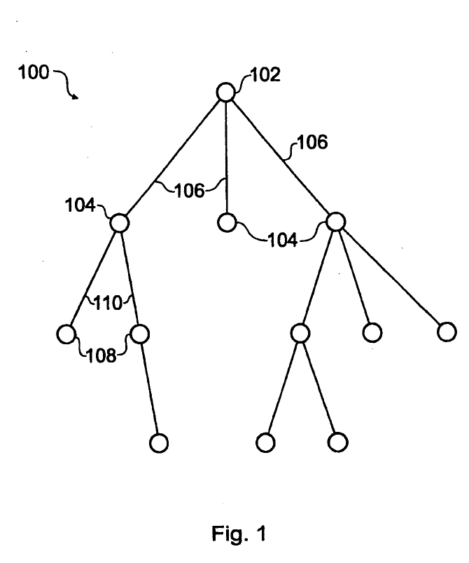

### DESCRIPTION OF PREFERRED EMBODIMENTS OF THE INVENTION

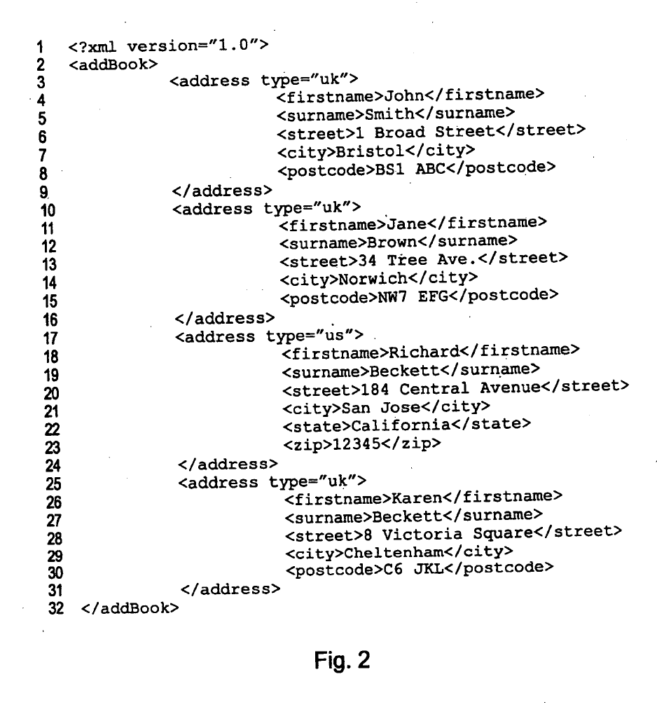

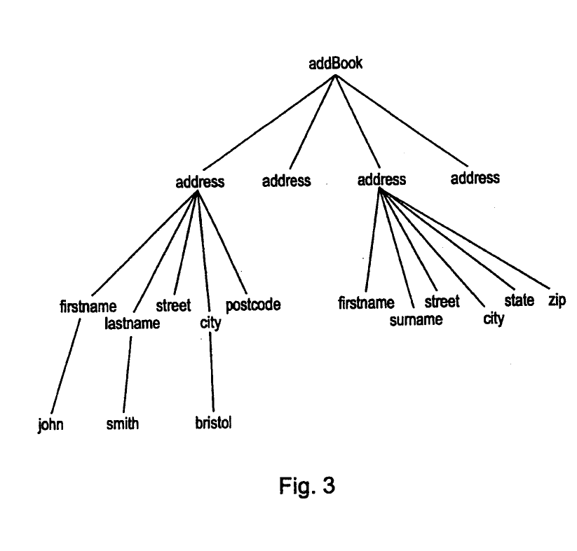

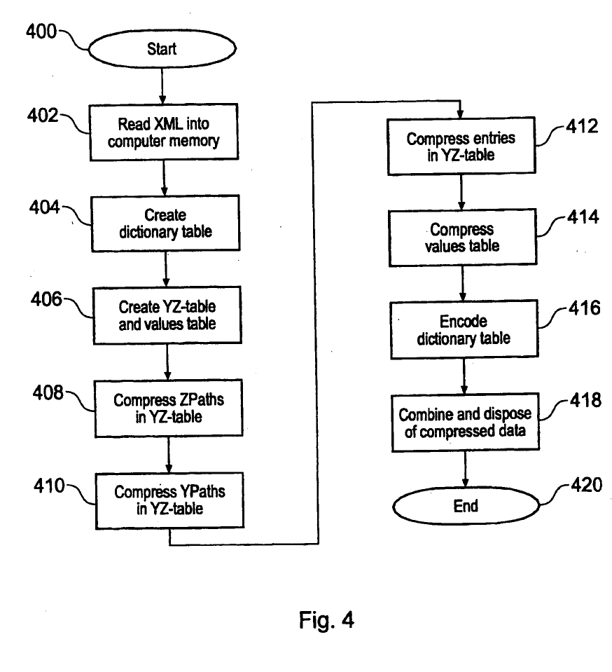

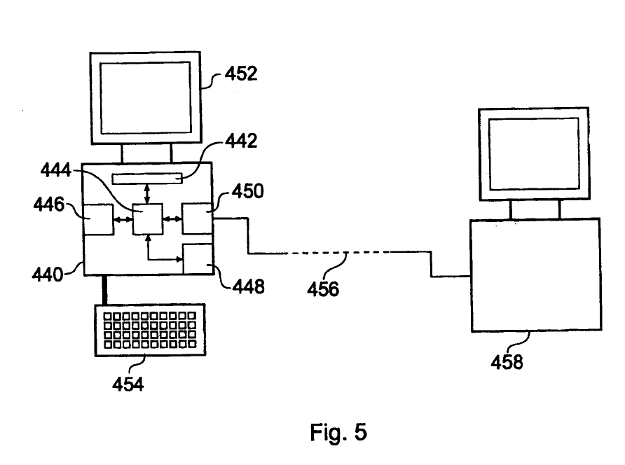

FIG. 4 shows a flow diagram of a method constituting an embodiment of the present invention for compressing a tree structure, such as that shown in FIG. 2, which in this example is an XML data structure. The data structure comprises data content (such as text nodes and attribute values) within data structure (such as elements) The method starts at step 400 from where control is passed to step 402. In step 402, the XML file to be compressed is read into computer memory. FIG. 5 shows an arrangement of a computer 440 suitable for reading the XML document into a memory 442 from a number of sources. The computer 440 includes a data processor 444 which is in communication with the memory 442, a permanent data storage device 446, a communications device 448 and a network interface 450. The computer is also connected to a display device 452 and an input device 454 such as a keyboard.

The computer 440 may read the XML file into memory 442 from the permanent data storage device 446, or from a network 456 to which the computer 440 may be connected via the network interface 450 or via an internet or e-mail connection. For example the XML file may be located on a second computer 458 which is also connected to the network 456. The file may be transmitted from the second computer 458 via the network 456, network device 450 and data processor 444 into the memory 442 of the computer 440.

Referring back to FIG. 4, once the XML file is located in memory, the next step 404 in the compression method is to create a dictionary table. The dictionary table serves to replace node names by a reference integer. However this is not essential, and node names may be replaced by any logical progression of symbols with which incrementation is available. For example, the node names could be replaced by letter tokens, with a sequence such as A, B, . . . , AA, AB, . . . . It is possible to increment using this sequence, for example increment from A to B, without complicated processing. This feature is desirable as the node names in the dictionary are compressed without their token value, which is regenerated on decompression.

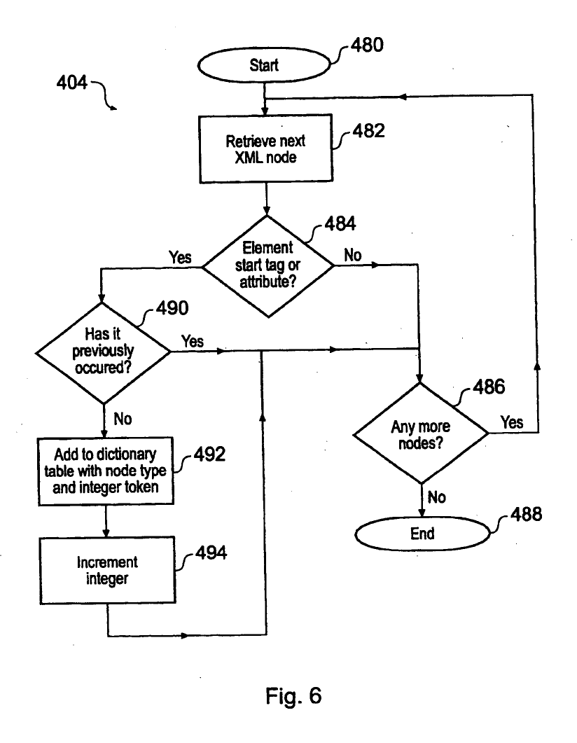

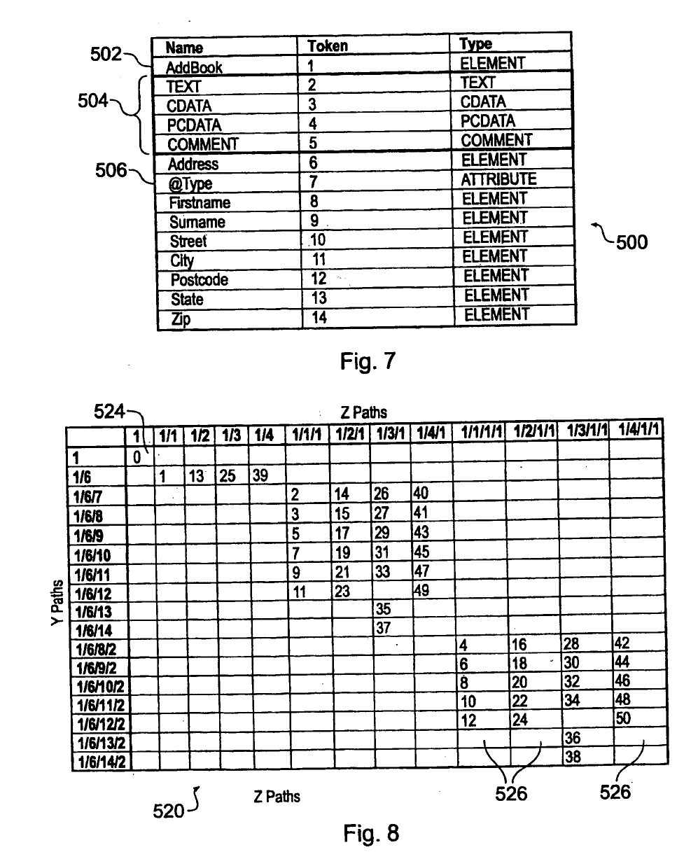

A flow diagram showing the details of step 404 is shown in FIG. 6. FIG. 6 shows the process of creating the dictionary table of the XML file. When this process is applied to the XML address book of FIG. 2, a dictionary table is created as shown in FIG. 7.

The process of creating the dictionary table starts in FIG. 6 at step 480 from where control is passed to step 482. At step 482 the next node in the XML document is retrieved. This may be an element start tag, attribute, text node or other type of node.

From step 482 control passes to step 484 where the node is evaluated to determine if it is an element start tag or an attribute. If it is neither then the process proceeds to step 486, where a test is made as to whether there are any more nodes in the XML file. If there are further nodes, then the control returns to step 482, otherwise control is passed to step 488 where the process for creating the dictionary table ends.

If it is determined at step 484 that the node is an element start tag or an attribute, then the process proceeds to step 490 where a test is made to determine whether any start tag or attribute with the current name has occurred previously in the XML file. To determine this the partially completed dictionary table is checked to see whether an entry has already been made under the same element or attribute name. If the entry has occurred before then the process proceeds to step 486, whereas if the element or attribute name has not previously occurred, the process proceeds to step 492. At step 492 a new entry is made in the dictionary table. Each row of the table contains the name of the element or attribute that has been encountered, a “token” which is a consecutive integer, and an indication of the type of node (whether it is an element or an attribute). The first entry is given the token value of 1. The root element (in this case “addBook”) is always the first element start tag and always appears before any attribute, therefore it always appears as the first entry in the dictionary table with a token value of 1. This can be seen in the dictionary table 500 shown in FIG. 7. The root element “addbook” is found in the first row 502, with the token value 1 and a type “ELEMENT”.

The next four entries 504 in the dictionary table are advantageously reserved for reserved-type fields such as text or comments. The node names TEXT, CDATA, PCDATA and COMMENT appear as entries 2 to 5 alongside token values 2 to 5 respectively. This occurs regardless of whether such nodes appear in the XML file or not, and regardless of the position in which they are first found. This is however not essential to the invention. The node type corresponds to the node name, so for example the TEXT node is of the TEXT type.

Referring back to FIG. 6, once an entry has been inserted into the dictionary table 500 at step 492, the process proceeds to step 494 where the token which is to be assigned to the next entry is incremented. However where reserved names are maintained, the token value needs modification to ensue that new entries are not assigned token values 2 to 5 which would cause a clash of token values with the reserved dictionary table entries 504.

Attribute names are entered into the table with a preceding “@” character. This is done so that the stored attribute name is consistent with the name that appears in the XPath for the attribute. For example, the attribute “type” within the first “address” element in line 3 of the XML data structure shown in FIG. 2 has the XPath addBook[1]/address[1]/@type, as explained above. Therefore “@ type” is added to the dictionary table 500 as the attribute name, as shown in entry 506 of the table 500.

Once the token integer has been incremented in step 494 of FIG. 6, the process proceeds to step 486. Thus the remainder of the XML document is processed and a complete dictionary table 500 is produced as shown in FIG. 7 for the example XML address book of FIG. 2.

Referring back to FIG. 4, once the dictionary table 500 has been produced in step 404 of the method of compressing an XML data structure according to the invention, the method continues on to step 406.

In this step 406, the XML data structure is analysed to derive information about the structure of the XML data structure, thus creating a YZ-table. The YZ-table contains information about the structure of the XML data structure, and is a representation of the structure in which the occurrence of each item of data content is mapped against a representation of a navigation path to the data item. The navigation path is represented by the YPath and the ZPath of each item. A values table is also created in step 406. The values table contains the data content of the XML data structure, as it contains the data items such as the attribute values and the content of text nodes.

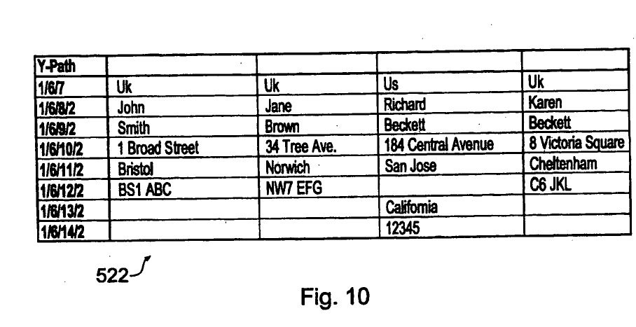

The process for producing YZ-table and values table will now be described. The example XML data structure of FIG. 2 results in the YZ-table of FIG. 8, and the values table 522 of FIG. 10.

The XML file is parsed from start to end on a node-by-node basis. When each node is encountered an entry is made in the YZ-table corresponding to the YPath and ZPath for that node. The YPaths are listed on the Y-axis of the YZ-table 520 shown in FIG. 8. The YPaths are arranged so that they are within groups of equal order, the lowest order group being listed first (ie those with the fewest elements take preference over those with more elements) and within groups of the same order numerical ranking by token value is undertaken. Within each group the YPaths are listed in order of occurrence of that particular YPath within the XML file. Common YPaths are listed only once. For example, there are four instances of addBook/address/firstname, but only one instance is listed in the Y-axis column of the YZ-table 520. Additionally, each node name in each YPath is replaced by its corresponding token in the dictionary table 500. For example the YPath addBook/address/firstname would appear as 1/6/8.

The step of replacing node names with tokens in the YPath may be performed when the YPath is added to the Y-axis. Alternatively it may be performed at some other stage, for example after the YZ-table has been completed. In the present embodiment the step of replacing the node names is performed as the YPaths are added to the Y-axis of the YZ-table 520.

The ZPaths are listed along the X-axis (horizontal direction) of the YZ-table. The ZPaths are arranged in groups of equal order starting with the group of the lowest order. Within the groups the ZPaths are arranged in the order in which they appear within the XML file. Common ZPaths are listed only once. For example, the firstname and lastname elements in lines 4 and 5 of the XML data structure of FIG. 2 both have the ZPath 1/1/1, which would appear only once in the X-axis of the YZ-table 520.

Before the XML file is processed to produce the YZ-table, the YZ-table is empty. As each node is encountered, a consecutive integer is added to the table against the corresponding YPath and ZPath of that node. If the YPath or ZPath does not exist in the appropriate axis then it is added, and ordered according to the ordering rules as described above. Thus the YPaths and ZPaths representing the structure of the XML data structure are manipulated individually when added to the YZ-table 520 in order that the YPaths and ZPaths are represented in a systematic fashion.

The added consecutive integers start at 0. As the first node is always the root element start tag which has the XPath addBook [1], or 1[1] when reduced using the dictionary table 500, the value 0 in the YZ-table always corresponds to the root element under the XPath 1 and ZPath 1. This is demonstrated in the YZ-table 520 of FIG. 8 in cell 524.

There will never be another entry in the same row as the root cell 524, as there cannot be another node within the XML file with the same YPath as the root node. Similarly there will never be another entry in the same column as the root cell 524 as there cannot be another node with the same ZPath as the root node. Thus the root could be omitted as it's existence can reliably be inferred.

Further nodes are added to the YZ-table using consecutive integers until all nodes have been added to the table. For the example XML data structure of FIG. 2, the completed YZ-table 520 is shown in FIG. 8. If a node has a data item associated with it, i.e. it is an attribute or reserved-type node (shown as entries 504 in the dictionary table 500 of FIG. 5), then that data is added to the values table 522 shown in FIG. 10. Thus the integers indicate the occurrence of an item of data content against a particular YPath and ZPath.

Values are added to the values table 522 such that each row in the values table 522 corresponds to a row in the YZ-table 520 which may contain data. For example, the row in the YZ-table 520 for the YPath 1/6/7 is associated with the “type” attributes within the “address” element start tags. The values for the attributes are inserted into the values table 522 into the corresponding row, indicated by the same YPath 1/6/7. A row in the values table 522 is created for each YPath in the YZ-table 522 which may contain data values, even if no data values are present. If no value is present for a particular YPath and ZPath then no integer is added to the YZ-table 520 in the corresponding cell. Similarly, the row in the values table 522 corresponding to that YPath will contain an empty cell. As a result, columns from the YZ-table 520 will correspond to the correct columns in the values table 522, when a row having a particular YPath is being considered. Entries in the YZ-table can only exist where the order of the YPath is equal to the order of the ZPath. Therefore empty cells are not created in the values table 522 which correspond to empty cells in the YZ-table 520 having a different order of YPath and ZPath.

An example of empty cells being added to the values table 520 occurs for the YPath 1/6/13/2, which corresponds to the “state” element. This element only occurs in the example XML data structure within “address” elements having the type “us”. Therefore other address elements do not have values associated with the state element. This is reflected by empty cells 526 in the YZ-table 520, and empty cells in the row of the values table 522 corresponding to the same YPath 1/6/13/2.

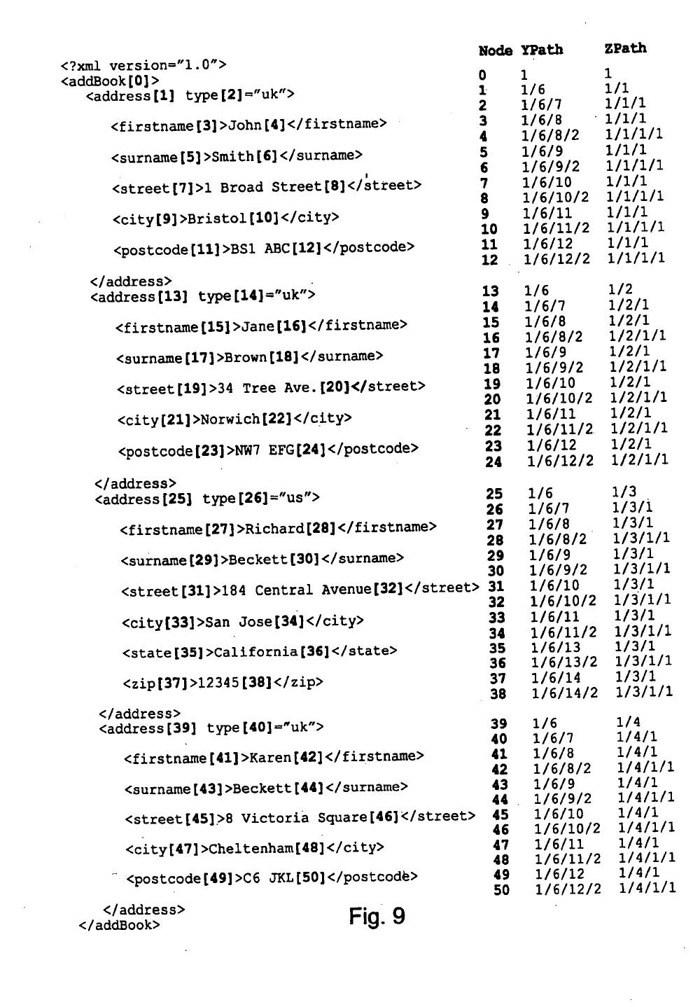

FIG. 9 shows, for the sake of exemplifying the creation of the YZ table, the XML file of FIG. 2 with an integer appended to each node. The integers are shown in bold and within square brackets for clarity. The integer represents the consecutive integer which would be inserted into the YZ-table 520 when each node is encountered. Alongside each line of the XML file is shown the node numbers contained with that line and the node's corresponding YPath and ZPath. This representation of the XML file of FIG. 2 is not created during the execution of the method but can be used to visualise the creation of the YZ-table of FIG. 8.

It should be noted that the attributes having node numbers 2, 14, 25, 40 in FIG. 9 have ZPaths which contain an ordinal position for the attribute. This is contrary to the definition of a ZPath as described above. The attribute being node number 2 has the ZPath 1/1/1 rather than 1/1. This representation is used so that attributes of an element can appear within the same column of the YZ-table 520 as the sub-elements of that element, as they have the same ZPath (unless there is more than one of a particular sub-element would have different ZPath). This is reflected in the YZ-table 520 of FIG. 8.

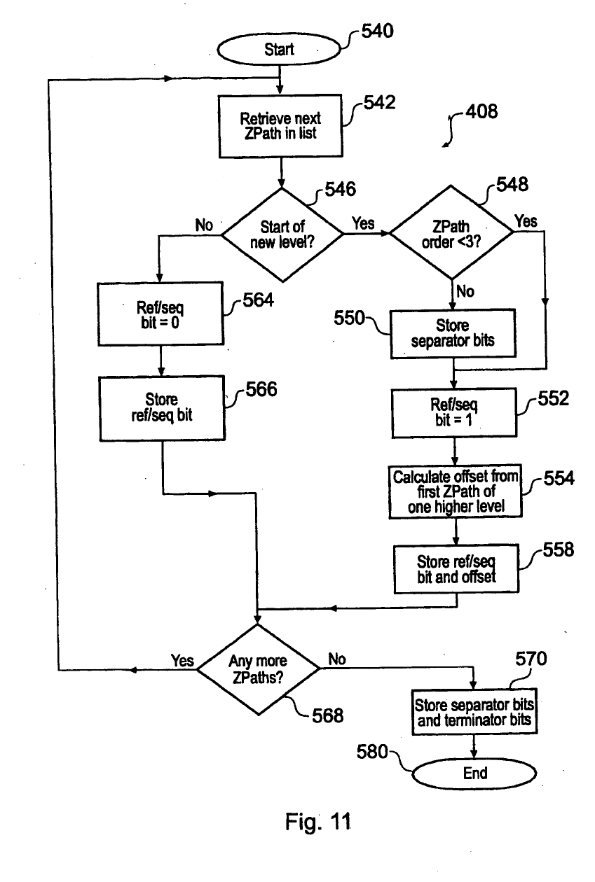

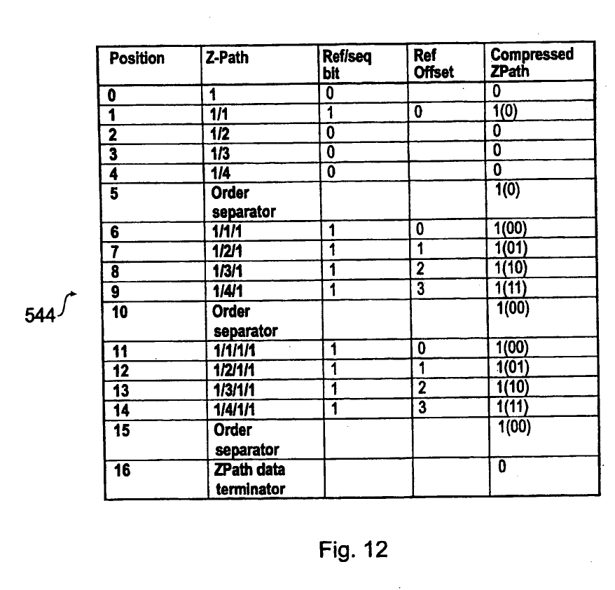

Referring back to FIG. 4, once the YZ-table and values table have been created in step 406 of the compression method, the method moves to step 408 where the ZPaths listed in the X-axis of the YZ-table 520 are compressed. This step is explained in more detail below with reference to FIG. 11, which shows a flowchart of the process for compressing the ZPaths, and FIG. 12 which shows a table which is used to visualise the ZPath compression.

However, it can be seen from visual inspection of the YZ table that there is a pattern to it and that data comes in clumps with the majority of table being empty. In fact two observations can be drawn from inspection of the table.

Reading the ZPath axis from left to right, either
1) A ZPath is the same as its immediate predecessor except that the last value of the sequence has been incremented by one. Such a progression of ZPaths can be referred to as a sequence; or
2) A ZPath is the same as an earlier ZPath except that it is one order higher, with the extra element in the sequence being of value “1”, e.g. 1/3/1 (order 3) is derived from 1/3 (order 2).

The process of compressing the ZPath values starts at step 540 of FIG. 11 from where control is passed to step 542. Step 542 carries out the retrieval of the next ZPath in the list of ZPaths forming the Y-axis of the YZ-table 520. The ordering from the table 520 is retained. The list of ZPaths can be seen in the ZPath column of a table 544 shown in FIG. 12, in the first column. Thus, lower order ZPaths (ie more significant ones) are treated before higher order ZPaths (more elements) regardless of the order of occurrence with the XML file. The retrieved ZPath is called the “current” ZPath.

The next step 546 in FIG. 11 is a determination of whether the current ZPath is the first of a new group of ZPaths in the list having a higher order (more elements) than the ZPath immediately preceding it in the list of ZPaths. If this is the case then the current ZPath must comprise one of the ZPaths in the group of the next lower level (ie hierarchically superior as it has one less element), with /1 appended to the end. Thus the current ZPath is a “reference” ZPath. This is because for the current ZPath to exist there must be a corresponding previous ZPath in the preceding order which is identical to the current ZPath up to the level of the previous ZPath. The final ZPath digit in this case must be 1 as there cannot be a second occurrence of a particular element without there being also a first occurrence. For example, the ZPath 1/1/2 cannot exist if there is not also a ZPath 1/1/1.

If the ZPath is the first in a group having a higher order, then control passes from step 546 to step 548. At step 548 a decision is made as to whether or not the order of the current ZPath is less than 3. If its order is less than 3, then control passes to step 550. At step 550 separator bits are stored. The separator bits inserted are identical to the encode bits used to encode the first ZPath in the previous group having a preceding hierarchical position, ie a lower order. The encoding will indicate a reference ZPath (which should not be decoded as it is merely a separator). For example, in the table 544 of FIG. 12 at position 6 is the first ZPath in the group of order 3, being 1/1/1. Therefore separator bits should be inserted before this ZPath is encoded. The first ZPath which is hierarchically significant (order-2) is 1/1 which is found at position 1.

The encoded bits which were used to represent this ZPath are 10. Therefore the bits 10 are stored in sequence of the encoded bits to indicate a group separator.

Control passes from step 550 to step 552 as shown in FIG. 11. However if it was determined at step 548 that the order of the current ZPath is less than 3, the method bypasses the step 550 and control passes straight to the step 552. This is because if the order is 1 then the current ZPath is the first ZPath being the root ZPath, and a separator is not required between it and any preceding ZPath. If the order is 2 then the previous order is 1 which can be the root ZPath only. Therefore a separator is not needed as only one ZPath of order 1 is expected.

For the purpose of compressing the very first ZPath corresponding to the root element, it is assumed that it is not the start of a new order. Thus it is compressed as if it were a sequence ZPath, which will be further described below. In practice this means it will be encoded as a single bit 0. It is however immaterial as to which bit is used to commence the sequence of compressed ZPaths.

At step 552, a ref/seq bit is set to 1. The reflseq bit is in general set to 1 to indicate a reference ZPath, and to 0 to indicate a sequence ZPath. By step 552 it has already been determined that the current ZPath is a reference ZPath.

To encode the current ZPath a reference to a previous ZPath must be created so that the ZPath can be taken and a “/1” appended to create the current ZPath. Therefore an “offset” is calculated at step 554, which follows on from step 552. The offset is the number of positions down the list of ZPaths, shown in the table 544 of FIG. 12, from the first ZPath of the hierarchically next most significant group, ie of one lower order, where the ZPath being referred to is located.

For example, in the table 544 of FIG. 12, a row at position 8 of the table 544 contains the ZPath 1/3/1. The column containing the position is merely for indicating the position in the table of a particular ZPath from 1/2/1. The ZPath in the row at position 7 immediately preceding the current ZPath is 1/2/1. Therefore 1/3/1 is not the next in a sequence of ZPaths. The concept of a sequence in the current context of ZPath compression is explained below. As it is not a sequence then the ref/seq bit is set to 1 to indicate a reference. The ref/seq bit for each ZPath is shown in the “ref/seq bit” column of table 544.

The first ZPath in the group at one lower level than the ZPath at position 8 of the table 544 is 1/1 which is found in the row of the table 544 at position 1. The ZPath that needs to be referred to is 1/3, which can be found at position 3 in the table 544 at position 3. This entry is found two positions down from the first in the group. Therefore the offset is 2.

After step 554, control passes to step 558 where the ref/seq bit (which is 1) followed by the offset is stored. The offset is also stored as a sequence of bits. The number of bits required to represent the offset is implied by the number of ZPaths present in the group of one order lower than the current ZPath. In the case of the example ZPath at position 8 in the table 544, there are four ZPaths in a group, comprising rows at position 1 to 4 as shown in FIG. 12. Therefore the offset can take a value between 0 and 3. The notation chosen to represent the offset is unsigned binary notation, where the leftmost bit is the most significant bit (MSB), and the rightmost bit is the least significant bit (LSB). This notation is well known to those skilled in the art. Two bits are therefore required to represent the range 0 to 3. In this example where the offset is 2, the bits “10” are used to represent the offset. The sequence of compressed bits representing the ZPath at position 8 is thus 110 (the ref/seq bit followed by the offset bits).

The bits are stored at step 558. The compressed bits for the list of ZPaths are stored in series for later retrieval. The bits may be stored on the memory 442 of the computer 440 shown in FIG. 5, on the permanent data storage device 446, or elsewhere.

If it is determined at step 546 in FIG. 5 that the current ZPath is not the first in a group of one higher level than the previous ZPath, then the current ZPath must be the next in a sequence of ZPaths. A sequence of ZPaths is where the last digit of the ZPath is incremented to move from one ZPath to the next. This is illustrated in the ZPaths at positions 2 to 4 of the table 544 of FIG. 12.

If the result of the determination in step 546 is that the ZPath is the next in a sequence, i.e. it is a sequence ZPath, then the process of ZPath compression passes to step 564.

In this step 564 the ref/seq bit is set to 0 to indicate a sequence ZPath. There is no previous ZPath being referred to, so there is no offset associated with the sequence ZPaths at positions 2 to 4 of the table 544, the position being indicated in the position column. The ZPath at position 1 is not a sequence ZPath as it is the first in a group at a particular level.

The next step is step 566, where the ref/seq bit (which is 0) is stored in the same fashion as for reference ZPaths as explained above. Thus only one bit is required to represent sequence ZPaths in compressed form.

Once the compressed bits have been stored in step 558 or 566, the process of ZPath compression proceeds to step 568 where it is determined whether there are any remaining ZPaths in the list which have not been compressed. If there are then the process returns to step 542.

If there are no more ZPaths in the list then control passes from step 568 to step 570. At step 570 a final separator is inserted in the same manner as described above. After this a terminator sequence of bits is inserted. Because each separator is normally followed by the first ZPath in a group of one higher order, which is always a reference ZPath, the next bit sequence following a separator should begin with a 1. Therefore a single bit 0 is sufficient to indicate the end of the compressed ZPath sequence. The final separator and terminator can be found in the example table 544 of FIG. 12 in positions 15 and 16 respectively.

Control passes from step 570 to step 580 which represents the end of the ZPath compression. Thus compression of the list of ZPaths is complete.

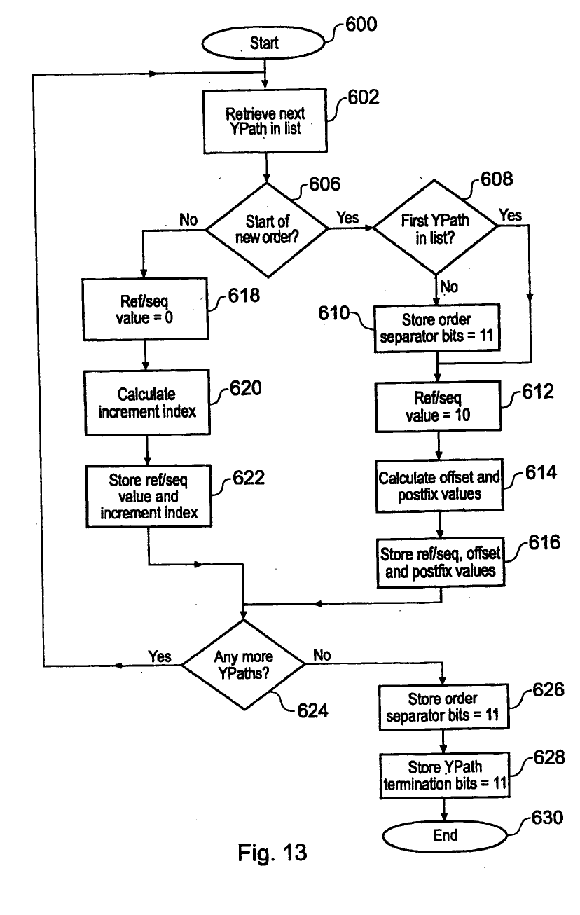

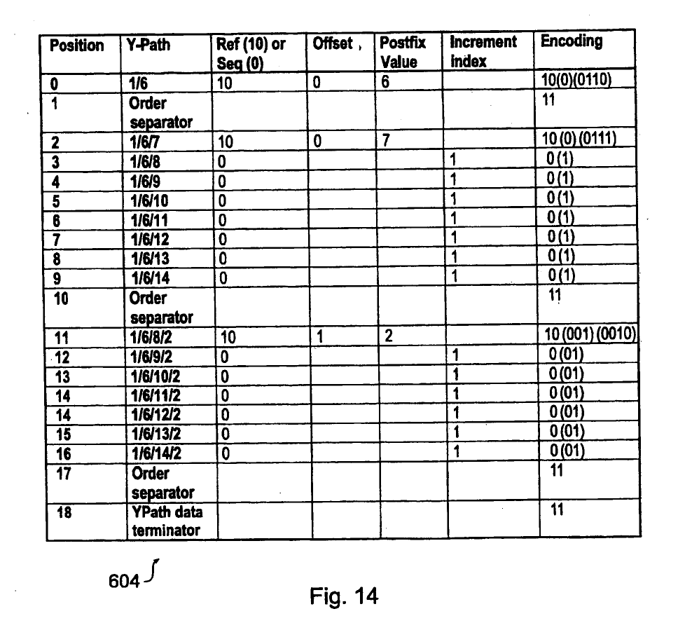

Referring back to FIG. 4, once the ZPaths have been compressed in step 408, control passes to step 410, where the list of YPaths in the Y-axis of the YZ-table 520 of FIG. 8 is compressed. This step 410 is explained in more detail below with reference to FIG. 13, which shows a flowchart detailing the steps in a method of YPath compression, and FIG. 14, which shows a table that can be used to visualise the YPath compression.

The method of compressing the YPaths starts at step 600 as shown in FIG. 13. The next step is step 602. As step 602 the next YPath in the list of YPaths is retrieved. The list of YPaths corresponds to the Y-axis of the YZ-table 520 as shown in FIG. 8. This list can be found in the YPath column of a table 604 shown in FIG. 14.

Once the next YPath has been retrieved, starting with the first YPath 1/6 shown at position 0 of the Table 604 of FIG. 14, control passes to step 606. It should be noted that the root YPath which consists of a single integer 1 is omitted from the list of YPaths for the purposes of compressing the YPaths. This is because the root YPath always appears before any other YPath in the list and has the value 1. Therefore it can be omitted from the compressed YPath dated as its existence is implied. The YPath 1/6 is therefore regarded as the “first” YPath in the list.

At step 606, a decision is made as to whether or not the retrieved YPath is the first in a group of YPaths having an order one higher (more elements) than the order of the immediately preceding YPath in the list. For the first YPath 1/6 it is assumed that the root YPath of 1 immediately precedes it.

If it is determined at step 606 that the YPath is the first of a new order, control passes to step 608. At step 608 a decision is made as to whether the YPath is the first in the list, in other words at position 0 in the table 604. If it is not, then control passes to step 610 where separator bits are inserted into the compressed YPath data to indicate that the end of the group of one order has been reached, and a group of a higher order follows. The bits which are inserted are “11”. This distinguishes from the situations described below where a single bit “0” is inserted to indicate a sequential YPath, or the bits “10” which indicate a reference YPath. Control then passes from step 610 to step 612.

If it is determined at step 608 that the YPath is the first in the list, then the separator bits are not required as there is no preceding group of a particular order in the preceding compressed YPath data. In this case step 610 is skipped and control passes to step 612.

At step 612, a two bit ref/seq value is set to “10”. This indicates that the current YPath is a reference YPath. A reference YPath comprises a YPath which has occurred within the group of one lower order which immediately precedes the group containing the current YPath, with an additional integer appended to it. It also indicates that the YPath is the first in the group.

From step 612, control passes to step 614. In this step an offset and postfix are calculated which can be used to construct the current YPath. The offset is the number of positions down the list of YPaths from the first YPath in the previous group to the location of the YPath being referenced. The YPath being referenced forms the first part of the current YPath. The postfix is the value to append to the referenced YPath to complete the current YPath.

For example, the YPath in position 11 of the table 604 shown in FIG. 14 is the first in a group of YPaths of order 4. The YPath is 1/6/8/2. The YPath 1/6/8 must exist in the previous group. It can in fact be found in position 3 of the table 604. The first YPath in the preceding group is in position 2 of the table. Therefore the offset of the YPath being referenced is 1, as it is the distance of item 1/6/8 from item 1/6/7 in table 604 The value to append to the referenced YPath is 2 to make the current YPath. Therefore the postfix value is 2.

The offset and postfix values for each reference YPath, where the ref/seq value comprises the bits “10”, are found in the respective columns of the table 604. These columns are empty for sequence YPaths and separators which do not use a reference or an offset.

After calculating the reference and offset in step 614, control then passes to step 616 where the ref/seq, offset and postfix values are stored in series to form the compressed data representing the current YPath. The ref/seq value always comprises the bits “10” for a reference YPath. The offset value can have a maximum value which references the last YPath in the previous group. In the example above where the YPath is 1/6/8/2 at position 11 in the table 604, the last YPath in the previous group is found in position 9. Therefore the maximum offset from position 2 is 7. The minimum offset is 0. Therefore a minimum of 3 bits is required to represent the offset for the current XPath. The offset is 1 which is therefore represented by the bits “001”.

The maximum value for the postfix value is the maximum token integer found in the dictionary table 500 of FIG. 7. The token in the present example of the XML address book has a range from 1 to 14. Therefore in this example 4 bits are required to represent the postfix value. This is true of all postfix values and is not affected by any preceding YPath data. In the example at position 11 of the table 604 of FIG. 14, the postfix value is 2 (indicating a “TEXT” node). Therefore the bits representing the postfix are “0010”. It follows that the complete set of bits representing the YPath at position 11 is “100010010”.

It should be noted that no separator is required between each sequence representing a single compressed YPath. This is because the number of bits making up a sequence is known as it is defined by the data itself and the preceding data. This applies equally when compressing the YPaths as it does when decompressing as explained hereinafter. As a result, sequences can follow directly on from one another and redundant separator bits are avoided. Therefore there is a space saving.

If at step 606 it was determined that the current YPath is of the same order as the previous YPath, then control passes to step 618 from step 606. In step 618 the ref/seq value is set to a single bit “0”. This indicates that the current YPath is a sequence YPath. A sequence YPath is identical to the immediately preceding YPath, except that one of the integers has been incremented. The integer which has been incremented cannot be assumed to be the last integer as for ZPath compression.

Therefore an increment index is required which indicates which integer in the previous YPath to increment to make the current YPath. Control passes from step 618 to step 620 where the increment index is calculated. All YPaths are of the form l/a/b/c/ . . . where a, b, c are positive integers. The first value is always 1 and is never incremented. Therefore it can be discounted for the purposes of defining an index for each other integer a, b, c. The convention chosen is that the index for a is 0, b is 1, c is 2 and so on.

For example, the YPath in position 12 of the table 604 of FIG. 14 is 1/6/9/2. The previous YPath is 1/6/8/2. Therefore the third integer needs to be incremented to make the YPath in position 12. Using the convention defined above, the integer to increment is “b” and has the integer index 1.

Having calculated the integer index in step 620 as shown in FIG. 13, control then passes to step 622. In this step 622 the ref/seq value (which is a single bit “0”) and the integer index are stored. The minimum number of bits required to represent the index arises from the order of the current YPath and the index of the last integer. The minimum number of bits is stored. Where the order of the current YPath is 2, the index can only take the value 0. However a single bit “0” is still used to represent this index in the present embodiment. In an alternative embodiment, the index may be omitted where the order is 2.

For the YPath in position 12 in the table 604, the index of the last integer is 2. Therefore the index range is 0 to 2. Two bits are required to represent the index. In position 12 where the index is 1, the bits representing the index are “01”. Therefore the complete sequence of bits representing this sequence YPath is “001”.

Again no separator is required after the sequence as the number of bits required is known.

After the bits representing the encoded YPath have been stored in step 616 or step 622, control passes to step 624, where it is determined whether there are any more YPaths in the list currently being processed. If there are further YPaths then control returns to step 602 thus the complete list of YPaths is processed and encoded.

If there are no further YPaths then control passes from step 624 to step 626, where two order separator bits “11” are stored in the encoded sequence to indicate the end of a group of particular order. This however does not indicate the end of the sequence of encoded YPaths. Bits following an order separator are expected to be either a single bit 0 to indicate a sequence YPath, or two bits “10” to indicate a reference YPath. Therefore two bits “11” are appended to the complete sequence to indicate the end of the encoded YPaths. This can be found in position 18 of the table 604 shown in FIG. 14.

The complete encoded YPath list (including separators) for the example XML address book data structure of FIG. 2 is
1000110 11 100011101 010101010101 11
100010010 001 001 001 001 001 001 11 11
   This is a total of 63 bits to represent the list of YPaths in this example.

Referring back to FIG. 4, once the YPaths have been compressed in step 410, control passes to step 412 where the entries in the YZ-table 520 are compressed.

The entries in the YZ-table comprise consecutive integers at the YPath and ZPath of the nodes they represent. However it is observed that the ordering of the nodes in a tree-like data structure is not important, provided that each node can be correctly associated with its parents, as explained below.

This information is present in the YZ-table 520 even if the consecutive integers are disregarded and taken as merely the presence of an entry. For example, node number 16 has a YPath 1/6/8/2 and a ZPath of 1/2/1/1. The immediate parent of this node must have a YPath and a ZPath of one lower order than this node. If the final digit of the YPath and ZPath of node 16 is removed, the resulting YPath is 1/6/8 and ZPath is 1/2/1. The node in the table 520 corresponding to these has the number 15, indicating that it is indeed the immediate parent of node 16. The parents of all of the nodes can be identified in this fashion, except for the root node which has no parent.

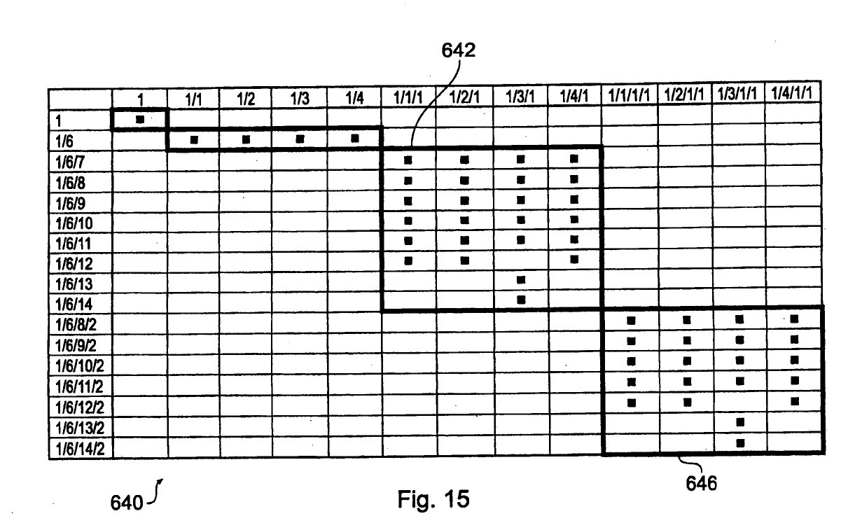

Therefore the structure of a tree-like data structure can be preserved, and the ordering of the nodes disregarded, by replacing the consecutive integers in the YZ-table 520 with binary indicators indicating whether there is an entry at each position. The resulting binary YZ-table produced from the example YZ-table 520 is shown in FIG. 15 as table 640. In this table 640 a black dot indicates the presence of an entry, whereas an empty cell indicates the absence of an entry.

Thus the problem of compressing the YZ-table has been changed to that of compressing a binary table. Binary image compression techniques are ideal for compressing the binary table, although other compression techniques may alternatively be used. One possible method of compressing the binary table using binary image compression is described below as an example only.

It has also been observed that entry may only exist in the YZ-table where the order of the YPath equals that of the ZPath. Therefore there are distinct separate rectangular regions outside of which an entry cannot exist. These regions have been highlighted in the example binary YZ-table 640 in FIG. 15 with a thick border around each region. For example, the region 642 encompasses all cells where the order of the YPath and ZPath is 3. This observation is only valid when the ZPath of attributes is extended as described above. If the axes of the YZ-table (ie the YPaths and ZPaths) are known, then the position and size of these rectangular regions can be determined from inspection of the axes.

The binary YZ-table can therefore be further reduced to a number of small rectangular regions to be compressed separately using a binary image compression method. Compression of the root node is not required as it is assumed to be present. Therefore the regions to be compressed correspond to YPaths and ZPaths of order 2 and higher.

An example of a binary image compression method is described in “Binary Image Compression Using Efficient Partitioning into Rectangular Regions”, by Sheri A Mohamed and Moustafa M Fahmy, IEEE Transactions on Communications, May 1995 pp. 1888. This method involves reducing a binary image to a number of non-overlapping rectangles, and then storing in compressed form the relative positions of the corners of the rectangles. In the context of compression of regions within the binary YZ-table 640, the position and size of each rectangle is not required in the compressed data as this information can be determined from the axes of the table.

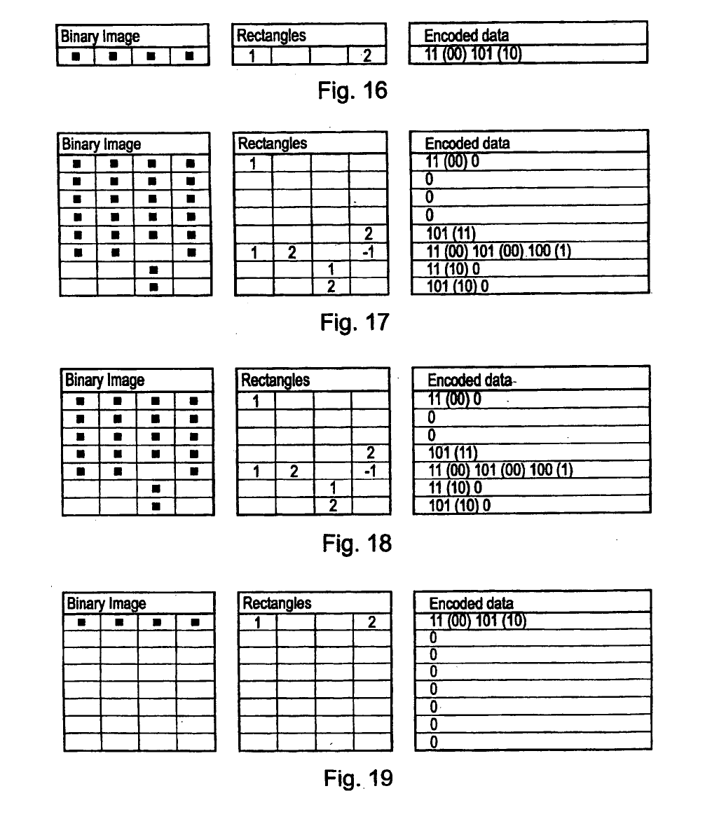

Compression of the example binary table 640 using this method is described below with reference to FIGS. 16 to 18. FIG. 16 illustrates compression of the order 2 entries in the binary YZ-table 640. FIG. 17 illustrates compression of the order 3 entries. FIG. 18 illustrates compression of the order 4 entries.

The method of compressing each binary image first involves finding non-overlapping rectangles within the image. The methods for doing so are described in the above mentioned reference and are not reproduced here, but the teachings are incorporated by reference. Each rectangle is then replaced with an integer “1” at the top left corner and an integer “2” at the bottom right corner. Individual pixels (ie rectangles with dimensions of 1 by 1) are replaced by a single integer “−1”. This is shown in FIGS. 16 to 18 under “rectangles” adjacent the appropriate binary image from the binary YZ-table 640 of FIG. 15.

To compress an image, each horizontal line is examined, starting from the top of the image. Each line is scanned from left to right. When an integer is encountered a single bit “1” is added to the encoded data. If the integer is a “1”, then another bit “1” is appended to the encoded data making “11”. If the integer is a “2” then two bits “01” are appended making “101”. If the integer is “−1” then two bits “00” are appended making “100”. There are no other integers which can occur.

Next, an offset is appended. This is the number of entries after the previous integer on that line where the current integer is located. If there are no previous integers on that line then the offset runs from the start of that line. The number of bits used to encode the offset depends on the number of entries in the line which follow the previous integer. If there is no previous integer then the number equals the number of entries in the line. The offset is encoded using unsigned binary notation as described above.

For example, the order 2 binary image comprises a single line as shown in FIG. 16 which is filled completely with entries. One rectangle is formed from this line as shown. The first integer “1” on the line is encoded using the bits “11” to indicate an integer 1, followed by the bits “00” representing the offset of 0. The offset is 0 because it is the first integer occurring along the line from left to right and it is not offset from the start of the line by any entries. Two bits are used to encode the offset as there are 4 entries along the line, and the possible range of the offset is 0 to 3. Unsigned binary representation is used, as for the offset for reference YPaths and ZPaths.

The next integer “2” along the line is found 3 entries to the right of the previous integer “1”, as shown in FIG. 16. As there are 3 spaces to the right of the previous integer, the possible range of the offset is 0 to 2. It is assumed that two integers cannot co-exist in the same space along the line, so an offset of zero indicates that the integer occupies the space immediately following the previous integer. The range 0 to 2 is represented by two bits, and the offset is 2.

Therefore, the encoded data representing the integer consists of the bits “101”, which is the symbol representing the presence of an integer “2”, followed by the offset bits “10”.

Thus the encoded data for the first line, and the whole image as it comprises only one line, of the order 2 entries shown in FIG. 16 is 11 00 101 10. No extra information is included as the dimension of the image as these can be derived from the binary YZ-table 640.

The encoded data for each line of each binary image in FIGS. 16 to 18 is found under “encoded data”. The offset bits are enclosed within brackets for clarity only.

If an integer is the last integer to be found along a line, and there are spaces following that integer, then an indication is required that there are no further integers along that line. This is achieved by introducing a single bit “0” at the end of the encoded data for each line. The encoded sequence normally expected at this point would be “11”, “100” or “101” indicating that an integer is present. These sequences begin with a bit “1”. Therefore only a single bit “0” is required to end the encoded data for a line. A single bit “0” is also sufficient to indicate a line with no integers, as shown in FIG. 19. If the last integer along a line is at the end of the line then no such indication is required as it is known there will be no further integers. This is the case for the order 2 line shown in FIG. 16.

It is also not required to include a marker at the end of the encoded sequence for one of the binary images as the end of the sequence will be self-evident from the known dimensions of the image.

The number of entries which need to be included in the compressed binary YZ-table can be reduced by using a technique called “autofilling”. This is based on the observation that a node with a particular YPath and ZPath (apart from the root node) must have an immediate parent having an identical YPath and ZPath with the last digit of each removed. For example, an entry exists in the example binary YZ-table 640 shown in FIG. 15 at a YPath of 1/6/8/2 and a ZPath of 1/2/1/1. The presence of this entry implies the existence of entries having the following YPath and ZPath pairs:

| YPath | ZPath |
|---|---|
| 1 | 1 |
| 1/6 | 1/2 |
| 1/6/8 | 1/2/1 |

Therefore the entries in the binary YZ-table 640 which can be implied by the existence of higher order entries can be ignored at compression time. Then, on decompression, the missing entries can be re-inserted, hence “autofilling”. This can often result in an improvement in the compression efficiency. In the example shown in FIG. 15, all of the order 2 entries can be implied by the existence of the higher order entries. Also, all of the order 3 entries except for the line corresponding to the YPath 1/6/7 (ie the “type” attribute) can be implied by higher order entries. Thus if these implied entries are removed and treated as empty cells, the number of encoded bits is reduced. The order 2 entries can be encoded as a single bit “0”. The order 3 image as shown in FIG. 17 can be replaced by that shown in FIG. 19, and it is shown that fewer bits are required to encode this reduced image. It is envisaged however that in some cases using this technique may increase the complexity of the images. In these cases, autofilling is preferably not used.

Referring back to FIG. 4, once the YZ-table entries have been compressed in step 414, control passes to step 416 where the values table 522 of FIG. 10 is compressed. This table 522 can be compressed using any of a number of methods available.

Each row of the table 522 contains data of the same type. For example, a row may contain only city names. An effective compression method therefore takes this into account by compressing each row separately using a different compression algorithm according to the data type.

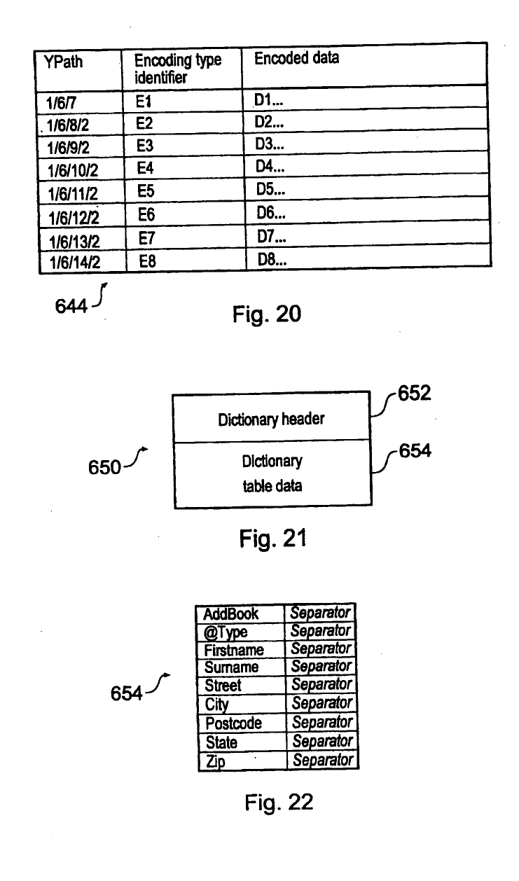

FIG. 20 shows a table 644 illustrating an example of the structure of the compressed values table. The YPath corresponding to each row of the values table 522 is not included in the compressed data. For each row, the compressed data comprises an encoding type identifier E1, E2, . . . followed by encoded data D1, D2, . . . . The encoding type identifier identifies the compression method used to compress that row of the values table. The identifier has a predetermined length. The encoded data represents the compressed values in that row. The length of each encoded row can vary based on the actual data and compression method used. The possible compression methods are numerous and will not be described here. However each method must be known by both the originator of the compressed data structure and any intended recipient. Each row contains data having the same YPath. Therefore the data itself will often be similar. Compression on a row-by-row basis can result in very efficient compression. For example, in the values table 522 of FIG. 10, the row corresponding to the YPath 1/6/7 holds data associated with the “type” attributes. The only values which occur are “uk” and “us”. This data can be highly compressed if a selected method (indicated by the identifier E1 in FIG. 20) takes advantage of the form of the data.

Referring back to FIG. 4, once the values table has been compressed in step 414, control passes to step 416 where the dictionary table is encoded. FIG. 21 shows the structure of the encoded dictionary table 650. The encoded table 650 comprises a dictionary header 652 and table data 654. The dictionary header 652 includes an indicator as to the encoding type of the node names in the dictionary table. For example, some encodings use two bytes per character. The header 652 also includes the number of dictionary entries. The header is of a predetermined length, depending on the number of bytes allocated for indicating the encoding type and the number of dictionary entries.

The dictionary table, an example 500 of which is shown in FIG. 7, includes columns indicating the token integer assigned to each node name and the type of node. The reserved node names 504 are not included in the reduced dictionary table as their presence is already known by any intended recipient of the compressed data structure. Also the token is not included as it is consecutive and can be calculated when extracting the dictionary table entries, subject to the presence of the reserved node names 504. Furthermore, the type column of the entries can only indicate that the node name applied to an element or an attribute (provided that the reserved names 504 are not compressed). The names of attributes are preceded by the “@” character. Therefore, the type column does not have to be included in the compressed dictionary table as the type of each node can be determined from the first character of its name.

Thus the only data that needs to be compressed is a list of node names, not including the reserved node names. The structure of the encoded dictionary table data 654 with unnecessary data removed is shown in FIG. 22. This data comprises the name of each node in the dictionary table, not including the reserved nodes, followed by a separator such as a carriage return line feed (CRLF) character or other character which would not occur within the node names themselves.

Referring back to FIG. 4, once the dictionary table 500 has been reduced in step 416, control passes to step 418 where the compressed data from previous steps is combined and disposed of.

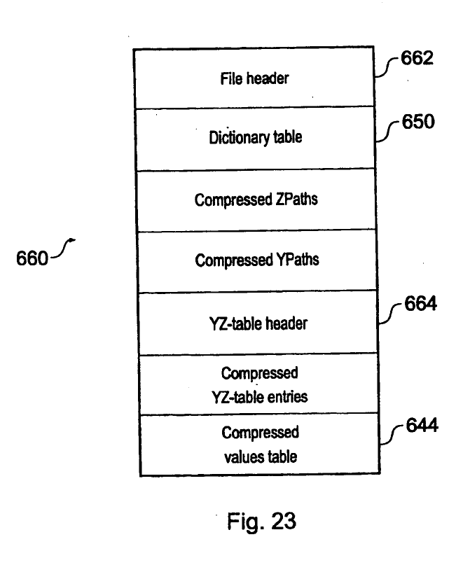

The compressed data from the previous steps are first combined into a single block of data. This is not essential to the invention but it facilitates storage and transmission of the compressed data structure. The layout of the final compressed data structure 660 is shown in FIG. 23. The structure comprises at the start a file header 662. This file header 662 may include information as to the length of the header 662 in bytes, the version number of the compression method, and any other desired information. The file header 662 is followed by the encoded dictionary table 650.

The encoded dictionary table 650 is followed by the compressed ZPath and YPath data. The reduced dictionary table preferably appears before the compressed YPath data as the number of dictionary entries affects the length of the compressed YPath data, and a decompressor needs to know the number of dictionary entries before it can decompress the YPaths.

The compressed ZPath and YPath data is then followed by a YZ-table header 664. This header 664 comprises a single bit to indicate whether autofilling is to be applied when decompressing the compressed YZ-table entries, as described above. A “1” indicates that autofilling should be applied. A “0” indicates that autofilling should not be applied and that no entry in the YZ-table should be implied.

The YZ-table header 664 is followed by the compressed YZ-table entries. This may comprise compressed binary images as described above. The compressed YZ-table entries preferably appears after the compressed YPath and ZPath data in the compressed data structure 660. This is because a decoder must decompress the YPaths and ZPaths in order to obtain the dimensions of the YZ-table (and any sub-regions of equal order) before it can decompress the YZ-table entries.

The compressed values table 644 follows the compressed YZ-table entries. This preferably appears after the compressed YPaths and ZPaths as the expected rows and table dimensions can be determined from the YPaths and ZPaths. The YPaths indicate the expected rows.

The combined compressed data structure 660, shown in FIG. 23, is given merely as an example and other arrangements are possible. However the compressed YPaths should appear after the dictionary table, and the compressed ZPaths and YPaths should appear before the compressed YZ-table entries. If these rules are not complied with then extra information must be included within the combined structure 660, so that a decompressor knows the length of the encoded data and can decompress it correctly.

Once the compressed data structure has been combined, it is disposed of. This may include saving it to a computer's permanent storage system 446 as shown in FIG. 5. Alternatively the combined structure may be transmitted to a recipient computer 458 using a network 456 via a network interface 450, or via an internet or e-mail connection. Alternatively the combined compressed data structure can be retained in the computer memory 442 for later storage and/or transmission.

Decompression

The process of decompressing the compressed XML data structure 660 will now be described, with reference to the example XML address book shown in FIG. 2.

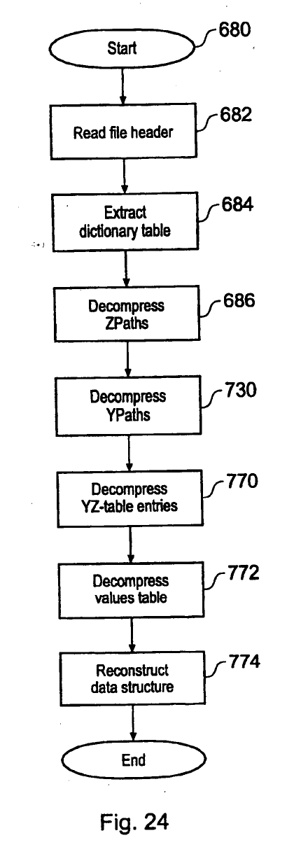

The process starts at step 680, as shown in FIG. 24, from which control passes to step 682. At step 682 the file header 662 of the compressed file 660 is read. The file header 662 may contain information, such as the length of the file header 662 and the version number (e.g. features included) of the XML data structure compression algorithm used to create the file 660. The decompressor may determine whether or not it is capable of decompressing the data structure based on the version number.

From step 682, control passes to step 684. At step 684 the dictionary table is reconstructed from the encoded data. The encoded dictionary table comprises a dictionary table header 652 followed by table data 654 as shown in FIG. 21. The header 652 includes information as to the number of dictionary entries and the encoding type used (such as bytes per character). This information is used to extract each name of the dictionary from the table data 654, the structure of which is shown in FIG. 22.

As each dictionary name is extracted, it is assigned an integer token one higher than the previous extracted name, with two exceptions. Firstly, the name of the root element has no previous extracted name so it is given the token value 1. Secondly, tokens must not be assigned the values of the reserved type nodes, which have token values 2 to 5 as shown in FIG. 7. Therefore the name following the root name is given the token value 6, the next the value 7, and so on. Each node name is separated by the predetermined separator character as described above. Therefore the length of each node name is clear. The number of names is also known from the dictionary header 652. Each extracted name is given the type “element”, except for names starting with the “@” character which are given the type attribute. In this way, the dictionary table 500 of FIG. 7 is fully reconstructed.

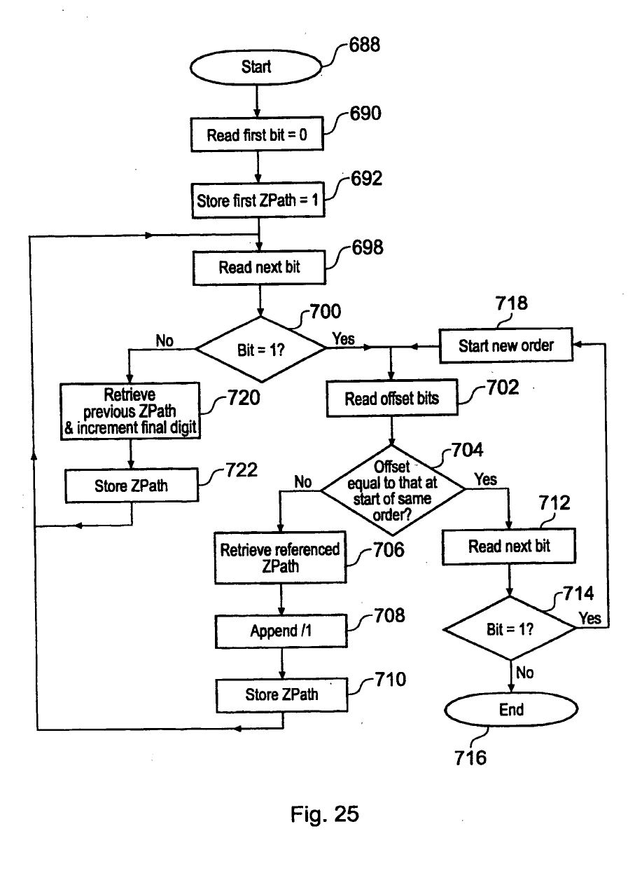

Referring back to FIG. 24, after the dictionary table has been reconstructed in step 684, control passes to step 686. At step 686 the ZPaths are decompressed, i.e. the compressed XML data structure is analysed to derive some information about the structure of the XML data structure. The process of decompressing the ZPaths starts, as shown in FIG. 25, at step 688. Control then passes to step 690. At step 690 the first bit of the encoded ZPath data is read from the compressed file 660. This first bit is 0. Control then passes to step 692 where the first ZPath is stored in a list of decompressed ZPaths. The first ZPath corresponds to the root node and has the ZPath “1”.

Control then passes from 692 to step 698. At step 698 the next bit of the encoded data is read. Control then passes from step 698 to step 700. At step 700 it is determined whether the bit read at step 698 is a 1 or whether it is a 0. If it is a 1 then the ZPath which is currently being extracted must be a reference ZPath. Control therefore passes from step 700 to step 702.

At step 702, offset bits are read from the encoded data. The offset bits follow on from the previous bit 1 indicating a reference ZPath. The number of offset bits is determined by the number of ZPaths present in the group of the next lower order. These have already been decompressed, so this number is known to the decompressor. The number of bits in the offset is the minimum number of bits required to represent the full range of possible values of the offset, in order to reference any one of the ZPath of the next lower order. Unsigned notation is used as described above. This method of representing the offset must coincide with that used when compressing the list of ZPaths.

After the offset bits have been read at step 702, control passes to step 704 which determines whether the sequence being examined is an order separator. Step 704 tests whether the offset read at step 702 is equal to the offset used in the reference ZPath at the start of the group of ZPaths of the current order. If this is the case, then an order separator has been located. If the ZPath currently being decompressed is the first ZPath of a particular order then this determination is assumed to return a false result.

If it is determined at step 704 that the offset is not equal to that at the start of the same order, then it is necessary to store a reference ZPath in the list of compressed ZPaths. Control therefore passes to step 706. At step 706, the referenced ZPath is retrieved. The referenced ZPath is that ZPath which is offset down (i.e. away from the root ZPath) from the first ZPath of the next lower order (near the root) by a number of places equal to the offset determined at step 702. The lower order ZPaths have already been decompressed due to the order in which the ZPaths were compressed.

Control then passes to step 708 where “/1” is appended to the retrieved ZPath. From step 708, control passes to step 710 where the ZPath is added to the end of the list of decompressed ZPaths. The referenced ZPath remains unaffected. Control then returns to step 698.

If it is determined at step 704 that the sequence is an order separator then the group of ZPaths of the current order has ended. Control therefore passes from step 704 to step 712.

At step 712 the next bit is read from the encoded ZPath data. Control then passes to step 714. At step 714 it is determined whether the bit read at step 712 is a 1 or a 0.

It is a 0 then this indicates the end of the list of ZPaths. Control therefore passes to step 716 where the process of decompressing the ZPaths ends. If it is a 1 then this is the first bit of a compressed reference ZPath, and this ZPath is the first ZPath in a group of a new and higher order than the ZPath previously added to the list of decompressed ZPaths. Control therefore passes from step 714 to step 718 where the decompressor notes that the current order has changed to the next higher order. Therefore the number of offset bits of this new reference ZPath can be determined correctly by inspecting the number of ZPaths in the group immediately preceding (lower order) this new reference ZPath. From step 718 control returns to step 702.

If it is determined at step 700 that the bit read at step 698 is a 0, then the ZPath currently being decompressed is a sequence ZPath. Control therefore passes from step 700 to step 720. At step 720 the last ZPath in the list of decompressed ZPaths is retrieved, and the final digit of that ZPath is incremented by 1. Control then passes to step 722, where the resulting ZPath is added to the end of the list. The ZPath retrieved in step 720 remains unaffected. Control then passes from step 722 back to step 698.

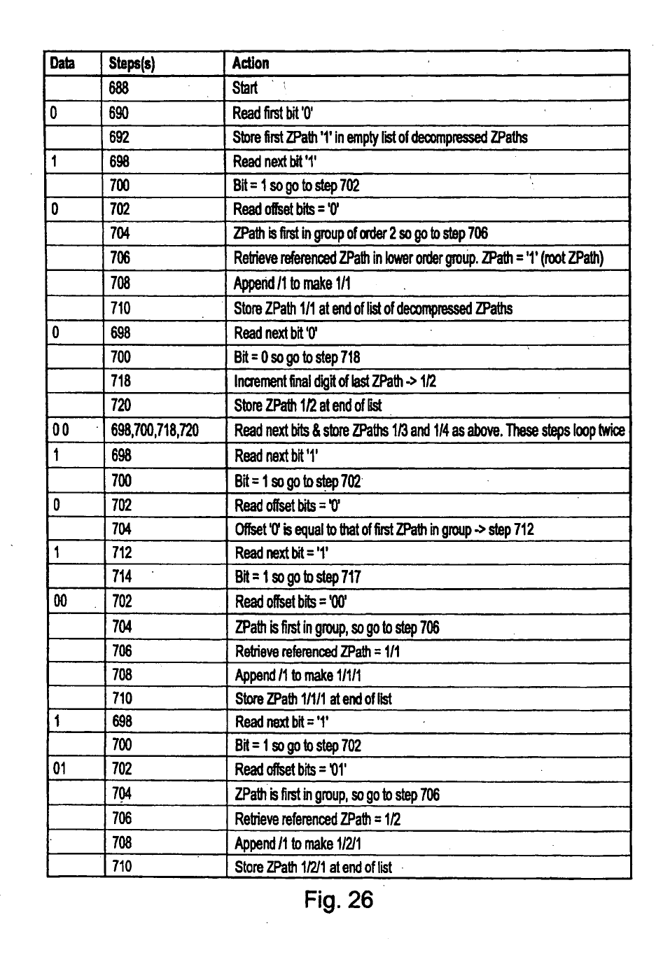

Thus the list of ZPaths is completely recovered from the compressed data in the order in which they were compressed. FIG. 26 shows a table of logical steps taken to decompress the first 7 ZPaths from the example compressed ZPath data shown in FIG. 12. The data column shows the bits which are read from the compressed ZPath data by that step. The step column shows the step from FIG. 25 which is being carried out in that line of the table. The action column provides a brief description of the operation of each step.

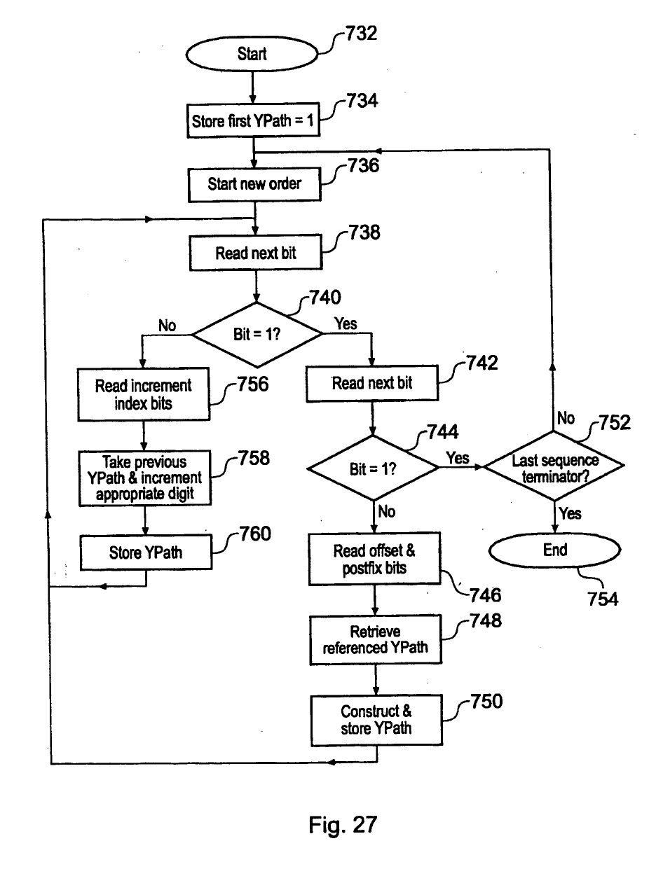

Referring back to FIG. 24, once the ZPaths have been decompressed in step 686, control passes to step 730. At step 730, the YPaths are decompressed from the compressed data, i.e. the compressed XML data structure is analysed to derive further information about the structure of the XML data structure. The process for decompressing the YPaths is shown in FIG. 27.

The process starts at step 732, from where control passes to step 734. At step 734, the first YPath is added to an initially empty list of YPaths. This YPath is “1” and corresponds to the YPath of the root element. Therefore it is not necessary to read from the compressed data to add this YPath. YPaths are added in reduced form wherein each integer corresponds to a node name in the dictionary table 500.

From step 734, control passes to step 736. At step 736 the decompressor notes that the next YPath to be decompressed has an order one higher than the order of the YPath which has most recently been decompressed. Thus the decompressor knows how many bits to expect when extracting the offset value from a compressed reference YPath. This is because the number of bits is dependent on the number of YPaths in the group of one higher order which has just been decompressed.

From step 736, control passes to step 738. At step 738, a single bit is read from the compressed YPaths. Control then passes to step 740, where it is determined whether the bit read in step 738 is a “1”, or a “0”.

If the bit is “1” then the sequence of bits currently being decompressed corresponds to either a reference YPath (comprising the bits “10” followed by offset and postfix data), or an order separator (comprising the bits “11”). Control therefore passes from step 740 to step 742.

At step 742, another bit is read from the compressed YPath data. Control then passes to step 744. At step 744 it is determined whether the bit read in step 742 is a “1”, or whether it is a “0”.

If the bit is “0” then the sequence currently being compressed is a compressed reference YPath, as the last two bits read (in steps 738 and 742 respectively) comprise the bits “10”. Therefore control passes from step 744 to step 746. At step 746 the offset bits followed by the postfix bits are read from the compressed data. The number offset bits is dependent on the number of YPaths in the group of the next lower order, as explained above, which have already been decompressed. The number of postfix bits is dependent on the number of node names in the dictionary table 500, which has already been extracted in step 684 as shown in FIG. 24. Therefore the decompressor reads the correct number of bits when retrieving the offset and postfix from the compressed data.

Control then passes from step 746 to step 748. At step 748 the referenced YPath is retrieved from the list of decompressed YPaths (which is incomplete at this stage). The referenced YPath is the YPath offset by a number of entries equal to the offset read in step 746 down (away from the root entry) the list from the first YPath in the group of the next lower order than the YPath currently being decompressed. This YPath has already been decompressed.

Control then passes from step 748 to step 750. At step 750 the postfix value read in step 746 is appended to the referenced YPath, thus increasing the order of this YPath by one. This resulting YPath is then stored by appending it to the list of decompressed YPaths. The referenced YPath remains unaffected. Control then passes from step 750 back to step 738.

If it was determined in step 744 that the bit read in step 742 is a “1”, then the sequence of bits currently being decompressed corresponds to an order separator, as the last two bits read (which were read in steps 738 and 742 respectively) comprise the bits “11”. Control therefore passes from step 744 to step 752.

At step 752 it is determined whether the sequence read immediately before the current sequence was also an order separator. If so, then control passes to step 754 where the process of decompressing the YPaths ends. This is because two consecutive order separators indicate the end of the compressed YPath data. Alternatively, if the previous sequence was not an order separator then control passes from step 752 back to step 736.

Returning to step 740, if it is determined in this step that the bit read in step 738 is a “0”, then the sequence currently being decompressed relates to a sequence YPath. A compressed sequence YPath comprises a single bit “0” followed by an increment index.

Control therefore passes from step 740 to step 756. At step 756, the increment index bits are read from the compressed data. The number of increment index bits is dependent on the order of the sequence YPath currently being decompressed, as detailed in the above description of YPath compression.

Control passes from step 756 to step 758. At step 758, the YPath which was most recently decompressed is retrieved from the list of decompressed YPaths. This YPath is at the bottom of the list. The integer in this YPath specified by the increment index read in step 756 is incremented by one. The increment index is arranged such that the second integer in the YPath from left to right has the index “0”, the third index “1” and so on. The first integer, which corresponds to the root YPath, is never incremented and hence is not given an index value. This reduces the possible range of the offset and hence may reduce the number of bits required to represent it.

Control then passes from step 758 to step 760. At step 760 the YPath produced in step 758 is stored by appending it to the list of decompressed YPaths. The YPath used to produce this sequence YPath remains unchanged. Control then passes from step 760 back to step 738.

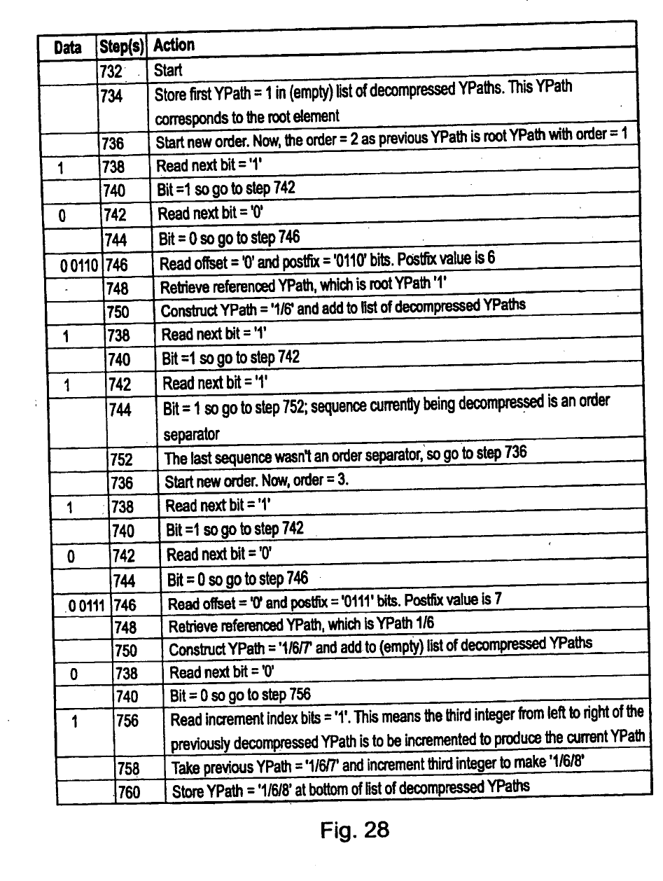

In this way the complete list of YPaths is fully reproduced from the compressed data. For the example compressed data shown in the table 604 of FIG. 14, a logical progression of the steps of FIG. 27 is carried out as shown in FIG. 28. FIG. 28 shows the steps taken to decompress the first 4 YPaths from the compressed data. Steps taken to decompress subsequent YPaths are not shown.

At this stage, the YZ-table 640 can be created from the decompressed YPaths and ZPaths, although the YZ-table would not yet contain any entries. These entries are stored in the compressed file 660 as a number of compressed binary images. The dimensions of these images are known from the YPaths and ZPaths in the empty YZ-table. It should be noted that the YPaths and ZPaths are compressed in the same order as they appear in the YZ table 520 shown in FIG. 8. Therefore no re-ordering of the YPaths or ZPaths is required after decompression.

Referring back to FIG. 24, once the YPaths have been decompressed in step 730, control in the process of decompressing the compressed XML data structure passes to step 770. At step 770, the YZ-table entries are decompressed and added to the empty table. The data comprising the compressed YZ-table entries follows that of the compressed YPaths. The process for decompressing the binary images is not explained here, but can be found in the paper by Sheri et al. on binary image compression referenced earlier. In brief, it involves extracting the top-left and bottom-right corners of the rectangles (and individual pixels), and filling in these rectangles to produce the original binary images. These images are then inserted into the YZ-table at the appropriate positions to fully reconstruct the YZ-table 640, an example of which is shown in FIG. 15.

The entry in the binary YZ-table for the root element, which has the XPath 1 [1], is not included in the compressed data. Therefore it must be added when the table 640 is being decompressed.

Referring back to FIG. 24, once the YZ-table 640 has been decompressed in steep 770, control passes to step 772 where the values table 522 is decompressed, i.e. the compressed XML data structure is analysed to derive information about the data content of the XML data structure, and to extract the data items.

The compressed values table 644 comprises distinct lines of data having the same YPath, from the values table 522 shown in FIG. 10. Each line is compressed using a particular compression method. Each line of compressed data comprises an identifier followed by encoded data, as shown in FIG. 20. The identifier indicates the method used to compress that line of the values table 522. Therefore the decompressor uses the identifier to correctly extract that line of the values table from the encoded data. This is done for each compressed line.

Each row of the values table is also associated with a particular YPath. Each YPath in the Y-axis of the decompressed YZ-table which values has a corresponding row in the values table 522 (FIG. 10). The row in the values table is present even if no values are present. The order in which the compressed rows are stored, and therefore the order in which they are decompressed, is the same as the order of occurrence of the corresponding YPath in the list of YPaths in the Y-axis of the YZ-table, starting with the YPath of the lowest order. Therefore the YPath associated with each decompressed row of the values table 522 can be obtained from the YZ-table 522. To determine the correct YPath, only YPaths which can take values are considered. Such YPaths correspond to reserved-type nodes and attributes found within the dictionary table 500.

Referring back to FIG. 24, once the values table 522 has been decompressed in step 772, control passes to step 774 where the binary YZ-table 640 and values table 522 are processed in order to reconstruct the XML data structure.

To reconstruct the XML data structure, firstly an empty XML document is created. This includes the line shown in FIG. 2 in line 1, which was not included in the compressed data Then the rectangular regions from the binary YZ-table 640 as shown in FIG. 15 are processed separately in increasing order as described below, starting with the region corresponding to the root element.

Each cell of the rectangular region is examined, starting from the top-left corner of the region and moving down each column. Where an entry in the table 640 is encountered, the YPath and ZPath of that entry are determined from the axes of the table 640.

If the entry encountered (called the current entry) corresponds to the root element, then the root element is added to the empty XML data structure and given the name corresponding to the token value of 1 in the dictionary table 500.

If the current entry does not correspond to the root node, then the YPath is split into two components, a parent YPath and a child YPath. The parent YPath comprises the YPath of the current entry with the final integer removed. This corresponds to the YPath of the element which is the immediate parent of the node corresponding to the current entry. The child YPath comprises the final integer of the YPath of the current entry. Similarly, the ZPath is split into a parent ZPath and a child ZPath.

The parent YPath and parent ZPath correspond to the element in the partially reconstructed XML document to which a new node should be added. The YPath is reconstructed by substituting token values for node names from the dictionary table 500. The XPath of the parent is then produced by combining the ZPath and the reconstructed YPath. The XPath can then be used to refer to the element to which a node should be added.

The child YPath comprises a single integer, which is a token corresponding to a node name in the dictionary table 500. The “type” column of the dictionary table 500 (shown in FIG. 7) indicates the type of node that should be added to the parent element. The type may be element, attribute, or a reserved-type node such as a text node.

The node is therefore added to the parent element as appropriate in the partially reconstructed XML data structure. Element nodes to be added are inserted as a child empty element tag of the parent element. The child element is given the name from the dictionary table 500 which corresponds to the token value found in the child YPath.

If the child YPath corresponds to a node which may take a value, for example a reserved-type node or an attribute node, then the correct value must be extracted from the values table 522, shown in FIG. 10. The correct value is found in the values table 522 in the cell in the row corresponding to the same YPath as the current entry, and in the column corresponding to the column in the decompressed YZ-table in which the current entry was encountered. The columns in the YZ-table which correspond to ZPaths of an order not equal to the order of the YPath of the current entry are not considered for the purposes of locating the correct value from the values table 522.

Attribute nodes take a name from the dictionary table 500, not including the initial “1” character, and a value from the values table 522. The attribute is inserted into the start tag of the parent element.

Reserved type nodes, for example text nodes, are added as data between the start and end tags of the parent element. This data is retrieved from the values table 522.

When inserting element or reserved type nodes, if the parent element comprises an empty element tag, this tag is replaced with start and end tags so that a child element or data may be inserted between them.

In this way, the original XML data structure is reconstructed from the compressed data. The order of occurrence of the nodes may be different from the original. However this does not affect the data structure itself as each node is associated with the correct parents.

The decompression process can be performed in a suitably programmed data processor.

It is thus possible to provide an efficient scheme for compressing and decompressing a hierarchical data structure.

1. A method of compressing hierarchical data, wherein the hierarchical data comprises data structure and data content within the data structure, and the method comprises the steps of:
a. analysing the hierarchical data to derive information about the data structure;
b. manipulating the data structure in order to represent it in a systematic fashion; and
c. compressing the data structure.

2. A method as claimed in claim 1, in which the step of analysing the hierarchical data includes step of creating a first representation of the data structure in which the occurrence of data items is mapped against a representation of a navigation path to the data item.

3. A method as claimed in claim 2, in which the occurrence of data items is associated with a YPath and a ZPath to the data item.

4. A method of claimed in claim 3, in which a compressed representation of the YPath is formed.

5. A method as claimed in claim 3, in which a compressed representation of the ZPath is formed.

6. A method as claimed in claim 2 in which the first representation of the data structure comprises a table in which one of the data items and markers indicating the existence of the data items are tabulated against the YPaths.

7. A method as claimed in claim 6, in which data items associated with one another are grouped together, such that items from one group do not become mixed with items of another group.

8. A method as claimed in claim 1, further comprising the step of creating a dictionary such that a data tag within the data structure can be represented by a symbol, where the symbol is generally smaller than the data tag.

9. A method as claimed in claim 3, where the first representation of the data structure groups the YPaths together within groups of equal order.

10. A method as claimed in claim 9, in which the groups of YPaths are arranged in accordance with the order of the YPaths such that those YPaths with fewest elements take preference over YPaths with more elements.

11. A method as claimed in claim 10, where within a group having a given order, the YPaths are arranged in order of occurrence of the data tags within the data structure.

12. A method as claimed in claim 3, in which the ZPaths are arranged in groups of equal order.

13. A method as claimed in claim 12, in which the groups of ZPaths are arranged with respect to the order of the ZPaths, with those ZPaths having fewer elements taking precedence over ZPaths having more elements.

14. A method as claimed in claim 13, where the ZPaths are compressed by examining the ZPaths in turn and determining for each ZPath whether it is the first of a new group of ZPaths having more elements than the ZPath immediately preceding it, and if so an order separator is inserted into the compressed representation of the ZPaths.

15. A data processor adapted to compress hierarchical data, wherein the hierarchical data comprises data structure and data content within the data structure, and the data processor is arranged to:
a. analyse the hierarchical data to derive information about the data structure;
b. manipulate the data structure in order to represent it in a systematic fashion; and
c. compress the data structure.

16. A data processor as claimed in claim 15, in which the data processor, when analysing the hierarchical data, creates a first representation of the data structure in which the occurrence of data items is mapped against a representation of a navigation path to the data item.

17. A data processor as claimed in claim 16, in which each indication is associated with a YPath and a ZPath to the item.

18. A data processor of claimed in claim 17, in which a compressed representation of the YPath is formed.

19. A data processor as claimed in claim 17, in which a compressed representation of the ZPath is formed.

20. A data processor as claimed in claim 16, in which the first representation of the data structure is a table in which the occurrences of the data item are tabulated against the YPaths.

21. A method of decompressing compressed hierarchical data, wherein the hierarchical data comprises data content within a hierarchical data structure, and the compressed hierarchical data comprises a representation of the data content and a compressed representation of the data structure in which indications of the occurrence of items of at least one of the data structure and the data content are mapped against a representation of a navigation path to each item; and the method comprising the steps of:
analysing the compressed hierarchical data to derive information about the data structure;
analysing the compressed hierarchical data to derive information about the data content; and
processing the information about the data structure and the information about the data content to produce the hierarchical data.

22. A method as claimed in claim 21, in which the indications of occurrence are associated with a YPath and a ZPath to each item.

23. A method as claimed in claim 22, in which the compressed representation of the data structure comprises compressed YPaths, compressed ZPaths and compressed indications of occurrence.

24. A method as claimed in claim 22, in which the indications of occurrence are representable as table having a first axis associated with the YPaths and a second axis associated with the ZPaths.

25. A method as claimed in claim 24, in which the compressed representation of the data structure includes a compressed form of the table.
